(19) United States
(12) Patent Application Publication
(10) Pub. No.: US 2008/0212332 A1
(43) Pub. Date: Sep. 4, 2008

(54) LED cooling system

(76) Inventor: David M. Medinis, Ft.Myers, FL (US)

Correspondence Address: Edwin W. Oldham, 400 Park Shore Drive, #200, Naples, FL, 34103, US

(21) Appl. No.: 11/712,382

(22) Filed: Mar. 1, 2007

(51) Int. Cl. F21V 29/00

(52) U.S. Cl. 362/373

(57) ABSTRACT

The invention relates to a LED cooling system that effects cooling of the LED's during use, and helps the LED's have a longer operating function, and uses less electricity for the LED's to operate. The use of cooling also provides a steadier light and has greater efficiency.

### I. BACKGROUND OF THE INVENTION

A. Field of Invention

The present invention pertains to LED lights which generate substantial heat during operation, and more particularly the provision of a method to cool the LED during operation to facilitate longer life to the LED, assure a steady light output during operation, and operation at the least power usage rate.

Some prior art apparatus have used relatively high-powered LED's to generate a desired high light output to be sufficient for the lighting requirement. Such LED's typically generate so much heat that a heat sink is required. Heretofore, the prior art has not been able to satisfy the requirement of an adequate heat sink or cooling system for a high intensity LED light generation.

B. Discussion of the Related Art

Several attempts to solve the problems described hereinabove have been made in the prior art. For example, published U.S. Pat. No. 6,955,444 published Jun. 2, 2005, and issues as a patent on Oct. 18, 2005 for Surgical Headlight by Sushil Gupta, teaches a head mounted lamp assembly with at least two LED's mounted side by side and focused utilizing a rear reflector. Such rear reflector use greatly diminishes the efficiency of the projection of the light generated by the LED, and thus is unsatisfactory for providing a high intensity focused or unfocused light beam of the apparatus of the invention.

U.S. Pat. No. 7,108,400 entitled Light Source Unit and Projector by inventors Shuhei Yamada and Takeshi Seto teaches the use of a LED light source for lamination of high luminants which includes a cooling system for this system which generates substantial heat. This design utilizes two liquid heat source absorbers and is very complex, and further is much more difficult to implement that the cooling system taught by the present invention.

U.S. Published Patent Application 22005/0243539 teaches a cooled light emitting apparatus comprising a light source including a close packed array of LED's and a cooling system for the LED's. The cooling system is a thermoelectric cooling system in the form of a peltier device connected by a heat spreader to the light source, and a second heat exchange system for removing heat from the peltier device. The heat exchange system utilizes a liquid coolant to cool the peltier device, and the combination of a heat pipe configuration as well. This is far less satisfactory than the single liquid cooling system taught by the invention.

### II. SUMMARY OF THE INVENTION

In accordance with the present invention there is provided a high intensity LED light source which because of its intensity creates heat during operation of the LED. Therefore, it is an object of the invention to provide use of a liquid source to provide cooling to the LED by mounting the LED directly to a heat kink metallic layer, and passing the liquid immediately adjacent to the heat sink layer with a sufficient flow rate so as to cool the LED to an optimum operating temperature and hence operational efficiency.

It is a further object of the invention to position the LED on a printed circuit board wherein there is a heat sink metallic layer immediately adjacent to the printed circuit board, and the base of the LED is metallic, and is in direct contact with the heat sink layer.

It is a further object of the invention is to provide a printed circuit board to which the LED is mounted which is between about 1 to 1.5 mm in thickness, and the heat sink layer is preferably made of aluminum, and is between about 2.0 to 2.5 mm in thickness, and that the coolant liquid is preferably water, and the flow rate of water adjacent the heat sink layer is approximately 400 ml per minute.

A further object of the invention is to utilize the cooling system for the LED whether or not the LED is focused or not, and where the cone of light emitted from the LED is approximately an 80 degree conically shaped beam of light.

### III. BRIEF DESCRIPTION OF THE DRAWINGS

A complete understanding of the present invention may be obtained by reference to the accompanying drawings, when considered in conjunction with the subsequent detailed description, in which:

FIG. 1 is a cross-sectional elevation showing the LED in combination with the mounting printed circuit board, and showing the LED in adjacent contact with the heat sink material, which is adjacent the cooling fluid flow to provide the cooling effect of the invention to the LED.

FIG. 2 is a cross-sectional elevation showing of a focusing lens showing the relationship between the cone of light emission from the LED, and the resulting condensing of that emission into a focused cone of light achieved by the focusing lens; and

FIG. 3 is a side view in schematic form showing the remotely located cooling and battery powered system assembly.

For purposes of brevity and clarity, components and elements of the apparatus of this invention will bear the same designation or numbering through the Figures.

### IV. DETAILED DESCRIPTION OF THE PREFERRED EMBODIMENT

The present invention provides a high intensity LED light which can operate at its best high intensity efficiency because of the combination of a very simplified cooling system to remove heat generated by the operation of the LED, and thus promote longevity of the LED, along with optimum performance thereof.

Referring first to FIG. 1 of the drawings, 10 indicates generally a LED, which is a high intensity light source that usually operates with an electric draw of at least about 1 amp, and puts out a light intensity of between 700 and 1200 lumens. It is this type of LED that generates heat which can affect the operating characteristics, life, etc. The LED 10 is typically with a polymer outer cover 12, the actual structure of the LED at 14, and a metallic mount 16, which is secured to a printed circuit board 18. The board 18 is directly in contact with a heat sink layer 20, meaning that the bottom surface of the mount 16 is in direct and intimate contact with the heat sink layer 20.

The cooling of the heat picked up by the layer 20 is achieved by incorporating a fluid flow path 22 having an input side 24 and an exit side 26. Preferably, the fluid utilized is water, and the flow rate on the water is preferably between 300 to 500 ml per minutes. The circuit board 18 is between 1.0 to 1.5 mm, and the heat sink layer is between 2.0 to 2.5 mm in thickness. The openings for the fluid flow paths 24 and 26 are between 1.0 to 1.75 mm in diameter.

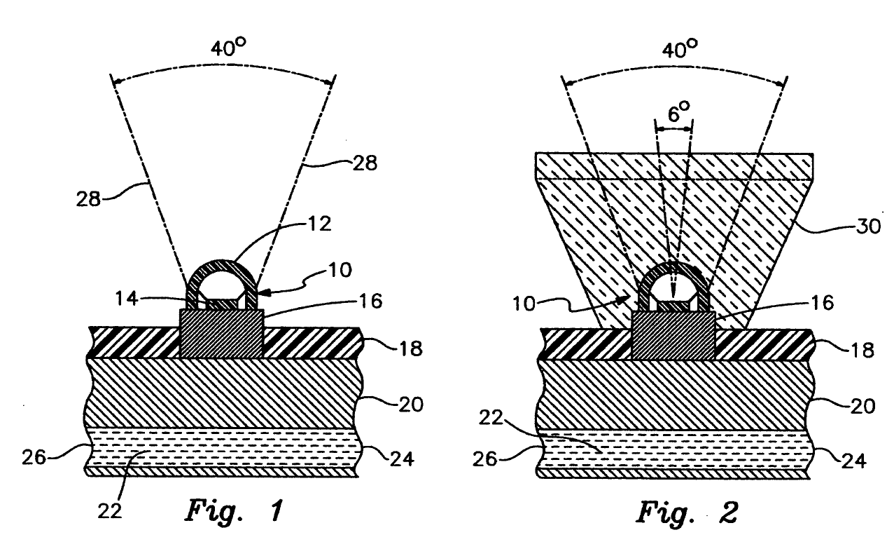

The LED typically produces a conical light pattern of about 40 degrees as shown by the dotted lines 28 showing the 40 degree span. This LED producing the approximately 40 degree pattern can be used for a multiplicity of purposes where brightness and a semi-coherent light is emitted by the LED. It is applicable to general lighting requirements where the light is not focused, as this is shown and will be described in connection with FIG. 2. The semi-coherent light emitted by the LED is in a lamberton distribution.

FIG. 2 is similar to FIG. 1 except that a focus lens has been added at 30. The focus lens 30 can achieve whatever focus is desired with the beam 28 from a specific focal point to an oval or circular shape at the point of focus. The example illustrated in FIG. 2 shows the beam 28 has been focused to a 6 degree output from the lens 30, and this is completely flexible to the nature of the end result desired in the emitted light. The 6 degree focused beam happens to be applicable to a surgical headlamp and provides a focal point in conjunction with other LED's in a circle positioned approximately 20 inches from the emission of the light from the lens 30.

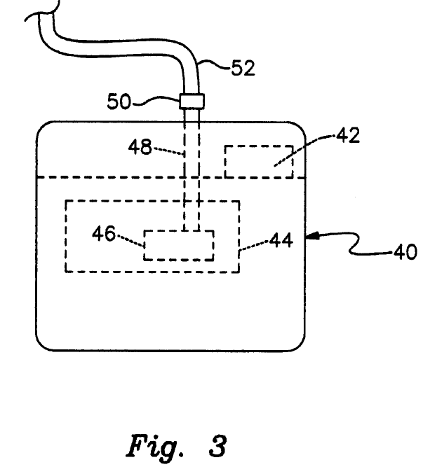

FIG. 3 shows a portable power pack and fluid pump indicated generally by 40 which can be used with the LED's of either FIGS. 1 and/or 2. It should be understood that this is just to depict a means for showing the components for operating the cooling system of FIGS. 1 and 2, but such system could be a permanent power source and pump with any suitable storage system for the cooling fluid.

In FIG. 3 the pack and pump 30 comprises a LED power supply indicated by dotted lines 42. The power supply is a conventional rechargeable battery typically used for any portable system and is conveniently located for replacement or recharging. The box or assembly 40 also incorporates a coolant reservoir 44 again shown in dotted lines, and the reservoir also contains a coolant pump 46 also indicated by dotted line within the assembly 40. The pump 4 transmits coolant fluid through the coolant tube 48, also indicated by dotted line. There is a quick connect or disconnect unit 50 located between the flexible tubing 52 that is the coolant fluid entering at 24 in FIGS. 1 and 2.

Since other modifications and changes vary to fit particular operating requirements and environments will be apparent to those skilled in the art, the invention is not limited thereto or thereby. Further, the invention is not considered limited to the examples for purposes or disclosure and covers all changes and modifications which do not constitute departures from the true spirit and scope of the invention. What is desired to be protected by letters patent is presented in the appended claims.

What is claimed is:

1. A high intensity LED light emission diode assembly including a metallic base which is powered to produce a cone of semi-coherent light in a lamberton distribution, which is characterized by
A printed circuit board mounting the LED whereby the metallic base of the LED extends through said printed circuit board to achieve mounting,
A metallic heat layer mounted on the side of the printed board opposite to the LED, and in intimate contact with the metallic base of the LED, and
Means to pass a fluid adjacent to the heat sink layer to absorb heat from the heat sink layer, and to effect operation of the LED at its optimum effect temperature.

2. A diode assembly according to claim 1 where the LED is operated with an electric draw of approximately 1 amp, and puts out a light intensity of between 720 to 1200 lumens.

3. A diode assembly according to claim 1 where the printed circuit board is between 1.0 mm to 1.5 mm in thickness and the heat sink layer is between 1.0 mm to 2.5 mm in thickness, and the fluid is water passing the heat sink layer at between 300 to 500 ml per minutes through an opening which is between 1.0 mm to 1.75 mm in diameter.

4. A diode assembly according to claim 3 where the diode assembly emits a conical light pattern of approximately 40 degrees, and further includes a focus lens to focus the 40 degree beam as desired.
